(19) United States
(12) Patent Application Publication
(10) Pub. No.: US 2004/0163903 A1
(43) Pub. Date: Aug. 26, 2004

(54) Disk brakes

(76) Inventor: Hironobu Saka, Nagoya-shi (JP)

Correspondence Address: BURNS DOANE SWECKER & MATHIS L L P, POST OFFICE BOX 1404, ALEXANDRIA, VA, 22313-1404, US

(21) Appl. No.: 10/784,174

(22) Filed: Feb. 24, 2004

(30) Foreign Application Priority Data
Feb. 24, 2003 (JP) 2003-046466

(51) Int. Cl. F16D 65/38

(52) U.S. Cl. 188/250 G

(57) ABSTRACT

A disk brake includes a disk rotor and a pair of pads. The pads are pressed against the disc rotor by a pressing device, so that a braking force is applied to the brake rotor. A shim is attached to each pad and opposes to the pressing device, so that a space is defined between the shim and each pad in order to retain a grease. Storage regions are defined within the shim in communication with the space in order to store and retain the grease. The storage regions are configured to retain the grease by utilizing the surface tension of the grease at least when the temperature of the grease is within a range of 20 to 200° C.

This application claims priorities to Japanese patent application serial number 2003-046466, the contents of which are incorporated herein by reference.

### BACKGROUND OF THE INVENTION

1. Field of the Invention

The present invention relates to disk brakes, and in particular to disk brakes having pads, pressing members for pressing the pads against a disk rotor, and shims interposed between the pads and the pressing members.

2. Description of the Related Art

In order to reduce the squealing of disk brakes, various measures have been proposed in the known art. For example, Japanese Laid-Open Utility Model Publication No. 3-322224 teaches a disk brake that includes pads with back plates, pressing members for pressing the pads against a disk rotor, and shims interposed between the back plates of the pads and the pressing members. A grease is filled into spaces between the shims and the back plates in order to reduce the squealing of the disk brake. An annular seal member is attached to the rear surface of each back plate along the outer periphery of the rear surface. The seal member is indicated by reference numeral 42 in FIG. 3 of this publication. The seal member is clamped between the corresponding back plate and the shim in order to retain the grease within the seal member. Therefore, the grease is prevented from possible leakage from the space between the shim and the back plate.

However, because the disk brake of the above publication requires the annular sealing members, parts costs as well as assembling costs increase. In addition, because the annular seal members are made of materials that are highly resiliently deformable, the annular seal members may deform at every time the pads are pressed by the pressing members against the brake rotor. Thus, the annular sealing members may deform in the same direction as the direction of the pressing forces applied by the pressing members. Therefore, when the disk brake is operated, the operation feeling may become unpleasant.

### SUMMARY OF THE INVENTION

It is accordingly an object of the present invention to teach improved disk brakes that have simple structures for preventing the squealing of the disk brakes.

According to one aspect of the present teachings, disk brakes are taught that include a disk rotor and a pair of pads. A pressing device serves to press the pads against the disk rotor in order to apply a braking force to the disk rotor. A shim is attached to each pad and opposes to the pressing device, so that a space is defined between each pad and the corresponding shim in order to retain a grease. Storage regions are defined within the shim in communication with the space in order to store and retain the grease. The storage regions are configured to retain the grease by utilizing the surface tension of the grease such that the openings of the storage regions are entirely covered by the grease at least when the temperature of the grease is within a range of 20 to 200° C. In other words, the storage regions may be filled up with the grease when the temperature range of the grease is 20 to 200° C. The temperature of 2° C. may be an environmental temperature and the temperature of 20° C. may be a possible highest temperature during the operation of the disk brake.

By the way, the known disk brake disclosed in the aforementioned Japanese Laid-Open Utility Model Publication No. 3-322224 also teaches storage regions that are configured as slits or through holes. However, this publication proposes to increase the width of the slits or the diameter of the through holes in order to increase the storage capacity of the storage regions. This may increase possible outflow of the grease from the storage regions. In particular, when the grease has been heated to a high temperature (e.g., 200° C.), the viscosity of the grease may be considerably lowered, so that the outflow of the grease may further increase. Therefore, as discussed previously, the disk brake of this publication requires a seal member in order to prevent the outflow of the grease.

In contrast, according to the above aspect of the present teachings, the storage regions are configured to retain the grease by utilizing the surface tension of the grease at least when the temperature of the grease is within a range of 20 to 200° C. Therefore, the storage regions can reliably store and retain the grease even at the high temperature (200° C.), so that the outflow of the grease can be inhibited or minimized without providing a seal member. Because no seal member is required, the construction of the brake device can be simplified and the operation feeling of the disk brake may not become unpleasant.

Although the storage regions are configured to retain the grease by utilizing the surface tension of the grease at least when the temperature of the grease is within a range of 20 to 200° C., the storage regions may be adapted to store the grease that has a temperature lower than 20° C. or a temperature higher than 200° C.

It is important to note that the storage regions of the known disk brake were never designed to positively utilize the surface tension of the grease, while the disk brakes of the above aspect of the present teaching is designed by taking into account of the surface tension of the grease at the high temperature (e.g., 20° C.). In addition, according to the known design of the disk brake, the grease may not entirely cover the openings of the storage regions and the surface tension may not be effectively utilized when the grease has been heated to a high temperature. Because the disk brakes of the above aspect of the present teachings may reliably store and retain the grease by utilizing the surface tension of the grease, unexpected remarkable effects (that cannot be attained by the known disk brake that does not effectively utilize the surface tension of the grease) can be attained.

In another aspect of the present teachings, the storage regions are configured as recesses. Each recess opens into the space between the corresponding shim and the pad and has a closed end on the side opposite to the space.

Preferably, the shim comprises a first shim member and a second shim member overlaid with each other and disposed on the side of the corresponding pad and the pressing device, respectively, so that the space is defined between the first shim member and the pad. The recesses may be formed within the first shim member in communication with the space and the closed ends of the recesses may terminate at the second shim member.

In another aspect of the present teachings, the recesses have elongated configurations and extend substantially parallel to each other. In such a case, the recess may be defined by slits formed in the first shim member. Preferably, the recesses extend along a substantially radial direction about a rotational axis of the disk rotor.

Alternatively, the recesses may have substantially circular configurations. In such a case, the recesses may be defined by circular through holes formed in the first shim member.

In another aspect of the present teachings, each of the recesses has a width within a range of 0.5 to 2.0 mm in case that the recesses have elongated configurations. Alternatively, each of the recesses may have a diameter within a range of 0.5 to 2.0 mm in case that the recesses have circular configurations.

With this determination of the width or the diameter of the recesses, the storage regions can reliably store and retain the grease at a temperature within a range of 20 to 20° C., in particular at the temperature of 200° C., i.e., a high temperature.

Results of experiments made by the inventor of the present application have indicated that the grease can be effectively stored and retained at a temperature within a range of 20 to 20° C. by the storage regions having the width or the diameter within a range of 0.5 to 2.0 mm. Presumably, if the width or the diameter of the storage regions is less than 0.5 mm, the grease may not easily enter the storage regions, so that a major portion of the grease may be retained between the shim and the pad. Therefore, the grease may not be effectively retained and stored within the storage regions and may easily flow out of the space between the shim and the pad. On the other hand, if the width or the diameter of the storage regions is greater than 2.0 mm, the grease heated to a high temperature (200° C.) and having a low viscosity may easily flow out of the storage regions.

### BRIEF DESCRIPTION OF THE DRAWINGS

FIG. 1 is a cross sectional view of a major portion including a disk rotor and pads of a first representative disk brake; and

FIG. 2 is an exploded perspective view of the pad and a corresponding shim of the first representative disk brake; and

FIG. 3 is a front view of a first shim member of the shim; and

FIG. 4 is an enlarged cross sectional view of a part of the disk rotor and the shim; and

FIG. 5 is a graph showing the relation between the outflow of a grease from the shim and the width of a storage region (slit) of the first representative disk brake and also showing the relation between the outflow of the grease and a diameter of a storage region (perforation) of a second representative disk brake; and

FIG. 6 is a front view of a first shim member of a shim of the second representative disk brake; and

FIG. 7 is a view corresponding to FIG. 4 but showing an enlarged cross sectional view of a part of a disk rotor and a shim of a known disk brake; and

FIG. 8 is a view similar to FIG. 7 but showing the outflow of the high temperature grease.

### DETAILED DESCRIPTION OF THE INVENTION

Each of the additional features and teachings disclosed above and below may be utilized separately or in conjunction with other features and teachings to provide improved disk brakes and methods of using such improved disk brakes. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

First Representative Embodiment

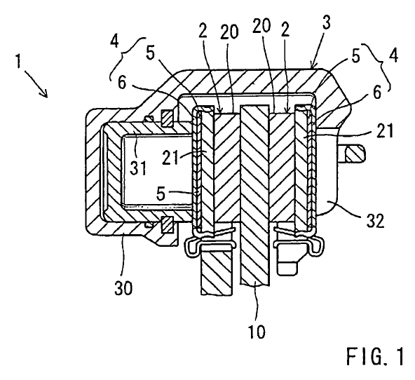

A first representative embodiment will now be described with reference to FIGS. 1 to 5. Referring to FIG. 1, there is shown a sectional view of a primary portion of a first representative disk brake 1 that is designed to be used for an automobile. The disk brake 1 includes a disk rotor 10, a pair of pads adapted to be pressed against the disc rotor 10 and a caliper 3 with cylinders 30. The pads 2 and the caliper 3 are supported by a mount (not shown).

The caliper 3 is slidably mounted on the mount via a slide mechanism, e.g., slide pins (not shown), so that the caliper 3 can move relative to the disk rotor 10 in a direction parallel to the rotational axis of the disk rotor 10. As shown in FIG. 1, the caliper 3 includes hydraulic cylinders 30 (only one cylinder 30 is shown in the drawings) that are disposed on the inner side of the caliper 3 with respect to the width of the automobile. A piston 31 is disposed within each cylinder 30 and is operable to move in a direction parallel to the rotational axis of the disk rotor 10 in response to a stepping force applied to a brake pedal (not shown), so that one of the pads 2 disposed on the inner side with respect to the width of the automobile (hereinafter also called “inner pad 2”) is pressed against the disk rotor 10.

As shown in FIG. 1, the caliper 3 includes claws 32 (only one claw 32 is shown in the drawing) that contact the other pad 2 disposed on the outer side with respect to the width of the automobile (hereinafter also called “outer pad 2”). When the pistons 31 are operated, the claws 32 move together with the caliper 3 relative to the mount, so that the outer pad 2 is pressed against the disk rotor 10 at the same time that the inner pad 2 is pressed against the disk rotor 10. In this way, the pistons 31 and the claws 32 serve as a pressing device for pressing the pads 2 against the disk rotor 10.

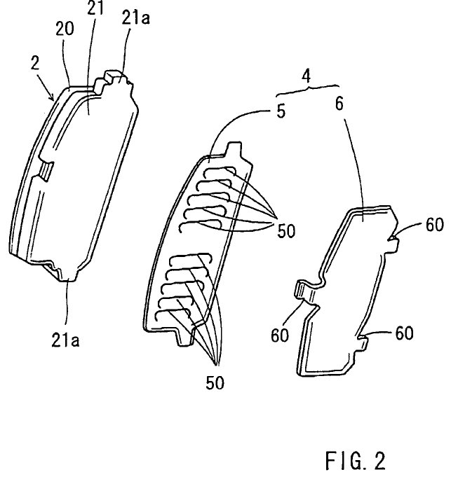

Referring again to FIG. 1, each of the pads 2 includes a friction member 20 and a back plate 21 that supports the rear side of the friction member 20. When the friction member 20 is pressed against the surface of the disk rotor 10, the friction member 20 produces a frictional force to prevent rotation of the disk rotor 10. As shown in FIG. 2, the back plate 21 includes a pair of guide projections 21a that extend upward and downward from the upper and lower ends of the back plate 21 (corresponding to the upper and lower portions of the disk rotor 10), respectively. The guide projections 21a are slidably received by corresponding guide recesses (not shown) formed in the mount, so that the pad 21 can slidably move in a direction parallel to the rotational axis of the disk rotor 10 relative to the mount.

As shown in FIG. 2, a shim 4 made of a metal plate is attached to the rear side of each pad 2. The shim 4 provides a vibration reducing effect in order to reduce the squealing of the disk brake 1. As shown in FIG. 1, the shim 4 on the inner side with respect to the width of the automobile is positioned between the pistons 31 and the back plate 21 of one of the pads 2 that opposes to the pistons 31. On the other hand, the shim 4 on the outer side with respect to the width of the automobile is positioned between the back plate 21 of the other of the pads 2 and the claws 32 of the caliper 3. A grease is filled into a space between each shim 4 and the corresponding pad 2 and serves to further reduce the squealing of the disk brake 1.

As shown in FIG. 2, the shim 4 includes a first shim member 5 and a second shim member 6 each having a configuration corresponding to the configuration of the rear surface of the back plate 21. The first shim member 5 may be positioned to cover the rear surface of the back plate 21 and the second shim member 6 may be positioned to cover the rear surface of the first shim member 5. The second shim member 6 has a plurality of engaging claws 60 that are formed integrally with the second shim member 6. The engaging claws 60 engage the back plate 21 with the first shim member 5 interposed between the second shim member 6 and the back plate 21. Therefore, the first and second shim members 5 and 6 are attached to the base plate 21 and are overlaid with each other such that the first shim member 5 is positioned on the side of the back plate 21 and that the second shim member 6 is positioned on the side of the pistons 31 or the side of the claws 32 of the caliper 3 (see FIG. 1).

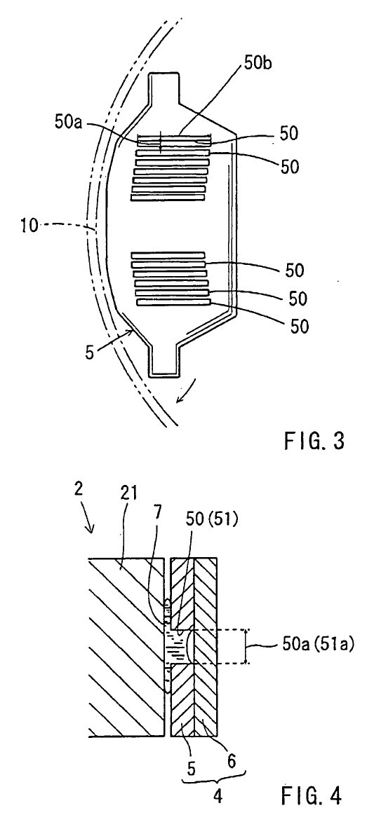

As shown in FIG. 3, a plurality of storage regions 50 are formed in the first shim member 5 and are adapted to store and retain the grease. In this representative embodiment, the storage regions 50 are defined by a plurality of parallel slits each having a predetermined width 50a and a predetermined length 50b and formed throughout the thickness of the first shim member 5. The storage regions 50 extend in a direction substantially parallel to short sides of the first shim member 5. This extending direction is perpendicular to the circumferential outline of the disk rotor 10 and corresponds to the radial direction of the disk rotor 10.

When the pads 2 have been accidentally shifted relative to the disk rotor 10 in the circumferential direction of the disk rotor 10 due to contact with the disk rotor 10, the grease may move in the circumferential direction of the disk rotor 10. However, the storage regions 50 can still reliably retain the grease because the storage regions 50 extend in the direction perpendicular to the moving direction of the grease.

Preferably, the width 50a of each storage region 50 is within a range of 0.5 to 2.0 mm in order to effectively retain the grease. The grease retained within the storage region 50 is indicated by reference numeral 7 in FIG. 4. As shown in FIG. 4, one end of the storage region 50 opens into the space between the first shim member 5 and the back plate 21 of the pad 2. The other end of the storage region 50 terminates at the surface of the second shim member 6. In this way, the storage region 50 is configured as a bottomed recess formed within the shim 4. Preferably, the storage regions 50 are configured such that each storage region 50 is entirely filled with the grease 7, so that the opening of each storage region 50 on the side of the pad 2 or the space is completely covered by the grease 7 when the temperature of the grease 7 is within a range of about 20 to 20° C. More specifically, the grease 7 may completely cover the opening of the storage region 50 by virtue of the surface tension of the grease 7. In general, if a disk brake is used under a harsh condition, the temperature around pads may increase to about 200° C. According to the representative embodiment, the grease 7 may cover the opening of each storage region 50 by virtue of the surface tension even at such a high temperature (200° C.), because the grease 7 can be reliably retained within each storage region 50 by the surface tension at least when the temperature range is 20 to 200° C.

Thus, the width 50a of each storage region 50 or the slit is determined based on the weight and the surface tension (or wetness) of the grease 7, in particular based on the weight and the surface tension at a high temperature (200° C.), in order to prevent the grease 7 from flowing out of the space between the back plate 21 and the first shim member 5. In addition, the grease 7 may enter the storage regions 50 by the capillary action.

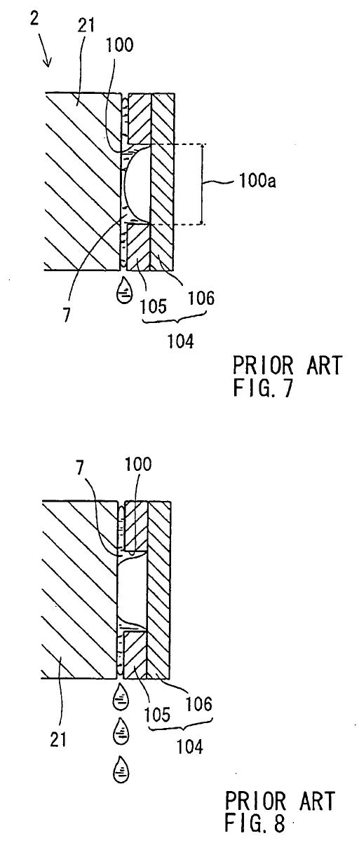

FIG. 7 is similar to FIG. 4 but illustrates a known art, in which a conventional storage region 100 is shown. The storage region 100 is defined by a slit formed in a first shim member 105 which forms a shim 104 together with a second shim member 106. The storage region 100 has a width 100a of about 3 to 4 mm. As the temperature of the grease 7 increases, the viscosity of the grease 7 may be reduced, so that the grease 7 may begin to flow out of the space between the back plate 21 and the first shim member 105 as shown in FIG. 7. When the temperature of the grease 7 reaches to about 20° C., the viscosity of the grease 7 may be further reduced and the grease 7 may further easily flow out of the space between the back plate 21 and the first shim member 105 as shown in FIG. 8, because the surface tension of the grease 7 is no longer effective to retain the grease 7 within the storage region 100.

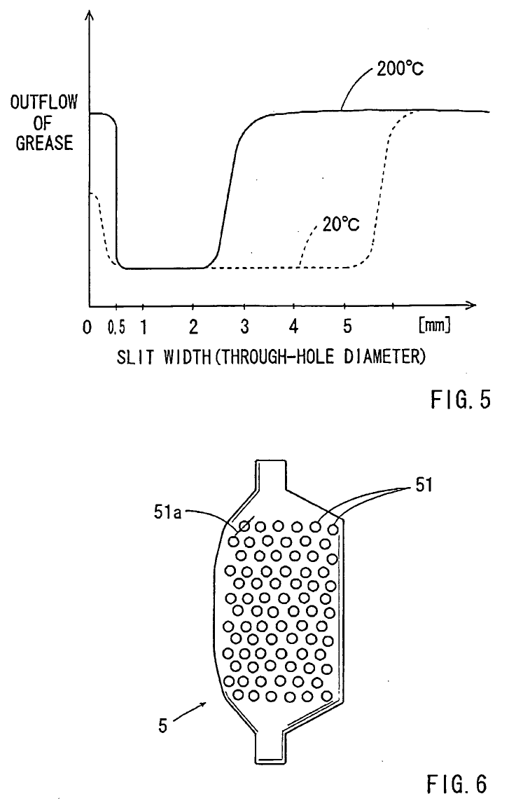

FIG. 5 shows results of experiments that were made by the inventor of the present invention with regard to the relation between the width of the storage region (slit) and the outflow of the grease. The grease used in these experiments is a silicon-based grease that may contain molybdenum disulfide and other additives and that is distributed under the trade name “ [symbol] ” (phonetically daikaruku) by Daishin Kako Kabushiki Kaisha of Tokyo, Japan. In FIG. 5, a dotted line indicates the relation at an environmental temperature (20° C.) and a solid line indicates the relation at a high temperature (200° C.). From these experimental results, it has been found that the slit width within a range of 0.5 to 2.0 mm (this range corresponds to the range incorporated into the first representative embodiment) provides very little outflow of the grease at both environmental temperature and high temperature in comparison with the outflow that occurs when the slit width is out of the range of 0.5 to 2.0 mm.

In case that the slit width is 0 to 0.5 mm, the outflow of the grease is great at both environmental temperature and high temperature. Presumably, this increase of outflow has been caused for the following reason. Because the slit width is too small, the grease cannot successfully enter the storage region. Therefore a major portion of the grease may be retained within the space between the back plate and the first shim member and may easily flow out of the space.

On the other hand, in case that the slit width is within a range of 2 to 4 mm, the outflow of the grease also is great when the grease is heated to a high temperature (200° C.). Because the viscosity of the grease becomes low, the grease may easily flow out of the storage region.

According to the first representative embodiment, the storage areas 50 are adapted to store the grease that has a temperature within a range of 20 to 200° C. and can reliably retain the grease either at the environmental temperature (20° C.) or the high temperature (200° C.). Although not shown in FIG. 5, substantially the same results as the case of the environmental temperature of 2° C. has been obtained in case that the environmental temperature is lower than 2° C. Therefore, as long as the grease is at the environmental temperature, the problem of unpleasant outflow of the grease may not be caused.

Preferably, the storage regions 50 may occupy 10 to 50% of the whole surface area of the first shim member 5. Thus, the length 50b and the number of the storage regions 50 may be determined to satisfy this occupation rate. In addition, the volume of the grease to be stored and the rigidity of the first shim member 5 may be appropriately determined by taking into account of the occupation rate.

As described above, according to the first representative embodiment, the storage regions 50 are configured to store the grease having a temperature within a range of 20 to 200° C. while the surface tension of the grease is utilized to retain the grease. Therefore, the grease may not flow out of the storage regions 50 even if the grease has been heated to 20° C. In addition, the disk brake 1 can be easily manufactured because a seal member as required in case of the previously described Japanese Laid-Open Utility Model Publication No. 3-32224 is no longer necessary. Further, because no seal member is necessary, the operation feeling of the disk brake may not become unpleasant when the disk brake is operated to apply a braking force.

Although the storage regions 50 of the representative brake device 1 are designed to store the grease having a temperature within a range of 20 to 200° C., the storage regions 50 may be adapted to store the grease having a temperature lower than 20° C. and may store the grease having a temperature higher than 200° C.

In addition, as discussed with reference to FIG. 4, the storage areas 50 are designed to store the grease 7 by taking into account of the surface tension of the grease 7 at the high temperature (200° C.). The storage areas of the known art have never been designed in order to positively utilize the surface tension of the grease. More specifically, although the storage regions 50 of the representative embodiment stores the grease 7 by utilizing the surface tension of the grease 7, the storage regions of the known art cannot effectively utilize the surface tension of the grease and the grease cannot successfully cover the openings of the storage regions if the grease is at the high temperature as discussed with reference to FIG. 8. Thus, the representative embodiment provides unforeseeable remarkable advantages over the known art that is not designed to effectively utilize the surface tension as discussed with reference to FIG. 5. Furthermore, the representative embodiment incorporates the slit width 50a within a range of 0.5 to 2.0 mm that was found to be most effective to enhance the ability of the storage regions 50 for storing the grease 7 from the experimental results.

Furthermore, because the grease 7 can be effectively retained within the storage regions 50 not to flow out of the shim 4, the ability of the grease 7 to inhibit or minimize the squealing of the disk brake 1 can be maintained during a long time use. In addition, because the outflow of the grease 7 is minimized, the number of necessary replenishment operations of the grease 7 can be reduced.

With regard to the materials of the first and second shim members 5 and 6 of the shim 4, the first and second shim members 5 and 6 may be made of metal plates, such as stainless steel plates. In addition, rubber materials, such as NBR (acrylonitrile-butadiene rubber), may be attached to the surfaces of the metal plates in order to configure the shim 4 as a composite shim. By virtue of the resilient deformation, the rubber materials of the first shim member 5 and the second shim member 6 of the shim 4 may disperse the pressure applied by the pistons 31 and the claws 32, so that the distribution of pressure applied to the surface of the shim 4 can be improved to enhance the squealing inhibition ability.

Second Representative Embodiment

A second representative embodiment will now be described with reference to FIG. 6. The second representative embodiment is different from the first representative embodiment only in a configuration of the first shim member 5, in which storage regions 51 corresponding to the storage regions 50 of the first representative embodiment are configured as substantially circular holes that are spaced from each other. In other construction, the second representative embodiment is the same as the first representative embodiment. Each of the storage regions 51 has a diameter within a range of 0.5 to 2.0 mm and extends throughout the thickness of the first shim member 5. With this configuration, the grease 7 can be reliably retained within each storage region 51. Thus, the grease 7 may be filled to be stored within each storage region 51 as shown in FIG. 4.

Similar to the first representative embodiment, the storage region 51 is configured to utilize the surface tension of the grease 7, so that the opening of the storage region 51 on the side of the pad 2 or the space may be reliably covered by the grease 7 when the temperature of the grease 7 is within a range of 20 to 200° C. To this end, the storage region 51 is designed to store and retain the grease 7 by the surface tension at least when the temperature of the grease 7 is within a range of 20 to 200° C.

The inventor of the present application has made experiments to determine the relation between the diameter of the storage region 51 and the outflow of the grease 7. The results of the experiments were substantially the same as the first representative embodiment (see FIG. 5). Thus, also with this second representative embodiment, the storage regions 51 can reliably store and retain the grease 7 when the temperature of the grease 7 is within a range of 20 to 200° C., in particular when the grease 7 is at a high temperature (200° C.).

The present invention may not be limited to the above first and second representative embodiments. The first and second representative embodiment may be modified in various ways. The followings are possible modifications of the first and second representative embodiments:

(1) Although the first and second representative embodiment has been described in connection with disk brakes that are known as “floating type” disk brakes, the present invention also may be applied to any other types of disk brakes, such as “opposing type” disk brakes, as long as shims similar to the shims of the first or second representative embodiment are incorporated.

(2) Although the storage regions 51 of the second representative embodiment has circular configurations, they may have different configurations, such as elliptical configurations and polygonal configurations including quadrangle configurations.

1. A disk brake comprising:
a disk rotor;
a pair of pads with respective back plates;
a pressing device arranged and constructed to press the pads against the disk rotor;
a shim disposed between the back plate of each pad and the pressing device and defining a space for storing a grease between the shim and the back plate, the shim comprising a first shim member and a second shim member overlaid with each other and disposed on the side of the back plate and the pressing device, respectively, so that the space is defined between the first shim member and the back plate; and
storage regions defined within the first shim member throughout the thickness of the first shim member in order to store and retain the grease; wherein:
the storage regions are configured such that the grease substantially entirely covers the openings of the storage regions and is retained within the storage regions by the surface tension of the grease at least when the temperature of the grease is within a range of 20 to 200° C.

2. A disk brake as in claim 1, wherein the storage regions comprise slits.

3. A disk brake as in claim 2, wherein each of the slits has a width within a range of 0.5 to 2.0 mm.

4. A disk brake as in claim 1, wherein the storage regions comprise substantially circular through holes.

5. A disk brake as in claim 4, wherein each of the through holes has a diameter within a range of 0.5 to 2.0 mm

6. A disk brake comprising:
a disk rotor;
a pair of pads;
a pressing device arranged and constructed to press the pads against the disk rotor;
a shim attached to each pad and opposing to the pressing device, so that a space is defined between each pad and the corresponding shim in order to store a grease, and
storage regions defined within the shim in communication with the space in order to store and retain the grease;
wherein the storage regions are configured to retain the grease by the surface tension of the grease such that the grease is filled up within the storage regions at least when the temperature of the grease is within a range of 20 to 200° C.

7. A disk brake as in claim 6, wherein the storage regions are configured as recesses each opening into the space and having a closed end on the side opposite to the space;

8. A disk brake as in claim 7, wherein the recesses have elongated configurations and extend substantially parallel to each other.

9. A disk brake as in claim 8, wherein each of the recesses has a width within a range of 0.5 to 2.0 mm.

10. A disk brake as in claim 8, wherein the recesses extend along a substantially radial direction about a rotational axis of the disk rotor.

11. A disk brake as in claim 7, wherein the recesses have substantially circular configurations.

12. A disk brake as in claim 11, wherein each of the recesses has a diameter within a range of 0.5 to 2.0 mm

13. A disk brake as in claim 7, wherein the shim comprises a first shim member and a second shim member overlaid with each other and disposed on the side of the corresponding pad and on the side of the pressing device, respectively, so that the space is defined between the first shim member and the pad, and wherein the recesses are formed within the first shim member in communication with the space and the closed ends of the recesses terminate at the second shim member.
